(19) United States
(12) Patent Application Publication
(10) Pub. No.: US 2013/0265811 A1
(43) Pub. Date: Oct. 10, 2013

(54) POWER CONVERSION APPARATUS HAVING CYLINDRICAL CASING INTEGRATED WITH CONNECTORS

(71) Applicant: DENSO CORPORATION, Kariya-city (JP)

(72) Inventors: Kazutoshi SHIOMI, Kariya-shi (JP); Masakazu TAGO, Aisai-shi (JP); Atsuyuki HIRUMA, Kariya-shi (JP)

(73) Assignee: DENSO CORPORATION, Kariya-city (JP)

(21) Appl. No.: 13/845,833

(22) Filed: Mar. 18, 2013

(30) Foreign Application Priority Data
Apr. 4, 2012 (JP) 2012-085359

(51) Int. Cl. H02M 7/00

(52) U.S. Cl. CPC H02M 7/003
USPC 363/146

(57) ABSTRACT

A power conversion apparatus converting power from the battery to be supplied to the load includes: a first substrate provided with a power conversion circuit; a second substrate provided with a control circuit; a casing having a casing body accommodating the first and second substrates; an input portion connecting a lead of an input harness connected to the battery; an output portion connecting a lead of an output harness connected to the load; an input connector integrated with the casing body to cover the input portion; and an output connector integrated with the casing body to cover the output portion. The input connector is configured to connect an end portion of the input harness to be mountable and demountable from/to the input connector and the output connector is configured to connect an end portion of the output harness to be mountable and demountable from/to the output connector.

### CROSS REFERENCE TO RELATED APPLICATION

This application is based on and claims the benefit of priority from earlier Japanese Patent Application No. 2012-85359 filed on Apr. 4, 2012 the description of which is incorporated herein by reference.

### BACKGROUND

1. Technical Field

The present disclosure relates to a power conversion apparatus that converts electric power and supplies an electrical load with the converted electric power.

2. Description of the Related Art

Conventionally, a power conversion apparatus in which the connecter is disposed to be integrated to the casing is known. For example, Japanese Patent No. 3731511 discloses a power conversion apparatus provided with a casing accommodating the power conversion circuit, wherein a connector is disposed in the casing so as to connect a harness used for a motor. In the power conversion apparatus according to the above patent document, the control circuit that controls the power conversion circuit is disposed outside the casing.

In the power conversion apparatus according to the above-described patent document, the power conversion apparatus and the control circuit are disposed to be fixed at different positions from each other so that when vibrations occur at the positions where power conversion apparatus and the control circuit are disposed, the vibrations propagate to the power conversion apparatus and the control circuit individually. Hence, since stress due to the vibrations may be localized at the lead wire that connects the power conversion apparatus and the control circuit, it is likely to damage the lead wire and affect electrical conductivity between the power conversion apparatus and the control circuit.

### SUMMARY

The embodiment provides a power conversion apparatus capable of favorably maintaining the electrical conductivity among the components used therefor.

According to the present disclosure, a power conversion apparatus that converts power from a power source to supply an electrical load with a converted power is provided. The power conversion apparatus includes a first substrate, a second substrate, a power conversion circuit, a control circuit, a casing, an input portion, and an output portion.

The power conversion circuit is mounted on the first substrate and configured to convert the power from the power source to generate the converted power. The control circuit is mounted on the second substrate and configured to control an operation of the power conversion circuit thereby supplying the electrical load with the converted power. The casing includes a casing body that accommodates the first substrate, the second substrate, the power conversion circuit and the control circuit. The input portion electrically connects a lead of an input harness that is connected to the power source. The output portion electrically connects a lead of an output harness that is connected to the electrical load.

In particular, according to the present disclosure, the casing includes an input connector integrated with the casing body to cover the input portion and an output connector integrated with the casing body to cover the output portion, the input connector connects an end portion of the input harness to be mountable and demountable from and to the input connector, the output connector connects an end portion of the output harness to be mountable and demountable from and to the output connector.

Thus, the power conversion apparatus according to the present disclosure is a connector-integrated power conversion apparatus that includes an input connector and an output connector, in which the input connector is capable of mounting/demounting an input harness and the output connector is capable of mounting and demounting an output harness

According to the present disclosure, since the power conversion circuit and the control circuit are integrated to the casing body, even when the power conversion apparatus is mounted at a portion where a vibration is likely to occur, vibration stress propagating separately to the power conversion circuit and the control circuit can be prevented. Therefore, the stress concentrating to an electrical conduction path between the power conversion circuit and the control circuit can be avoided.

As a result, comparing a conventionally-used power conversion apparatus including the power conversion circuit and the control circuit disposed separately (i.e., the power conversion circuit is accommodated in the casing body and the control circuit is disposed outside the casing body), with the power conversion apparatus of the present disclosure, the power conversion apparatus of the present disclosure can maintain favorable electrical conductance between the electrical components such as the power conversion circuit and the control circuit.

According to the present disclosure, the power conversion circuit, the control circuit, the input portion and the output portion are covered by the casing, whereby the power conversion circuit, the control circuit, the input portion, the output portion and connecting portions among these components suffering from external disturbance such as mechanical shock, heat, liquid material such as water and foreign materials having conductivity can be avoided. Moreover, when the casing is made of metal capable of shielding electromagnetic waves, electromagnetic noise entering to the power conversion circuit, the control circuit, the input portion, and the output portion can be suppressed. Also, electromagnetic noise produced by the above-described components radiating outside the casing can be suppressed. Furthermore, when the casing is made of, e.g. metal having relatively high thermal conductivity, the heat produced inside the casing can be promptly radiated outside the casing.

### BRIEF DESCRIPTION OF THE DRAWINGS

In the accompanying drawings:

FIG. 1A is a cross sectional view of a power conversion apparatus according to the first embodiment of the present disclosure;

FIG. 1B is a cross sectional view taken from line B-B of the FIG. 1A;

FIG. 1C is an enlarged cross sectional view taken from line A-A of the FIG. 1B, showing a vicinity of the power conversion circuit;

FIGS. 2A, 2B and 2C are diagrams showing a perspective view according to the first embodiment, wherein FIG. 2A illustrates an input harness and an output harness connected with each other, FIG. 2B illustrates the input harness and the output harness disconnected from each other, FIG. 2C illustrates a state that the input connector is cut from the casing body and an inside component is taken out from the casing;

FIG. 3 is a cross sectional view of a power conversion apparatus according to the second embodiment;

FIGS. 4A and 4B are diagrams showing the power conversion apparatus according to the third embodiment, wherein FIG. 4A illustrates a cross sectional view and FIG. 4B illustrates a perspective view; and

FIGS. 5A and 5B are diagrams showing the power conversion apparatus according to the fourth embodiment, wherein FIG. 5A illustrates a cross sectional view and FIG. 5B illustrates a perspective view.

### DETAILED DESCRIPTION OF THE PREFERRED EMBODIMENTS

With reference to the drawings, hereinafter is described the power conversion apparatus based on several embodiments of the present disclosure. It is noted that substantially the same elements are labeled with the same reference numbers and redundant description thereof is omitted.

### (First Embodiment

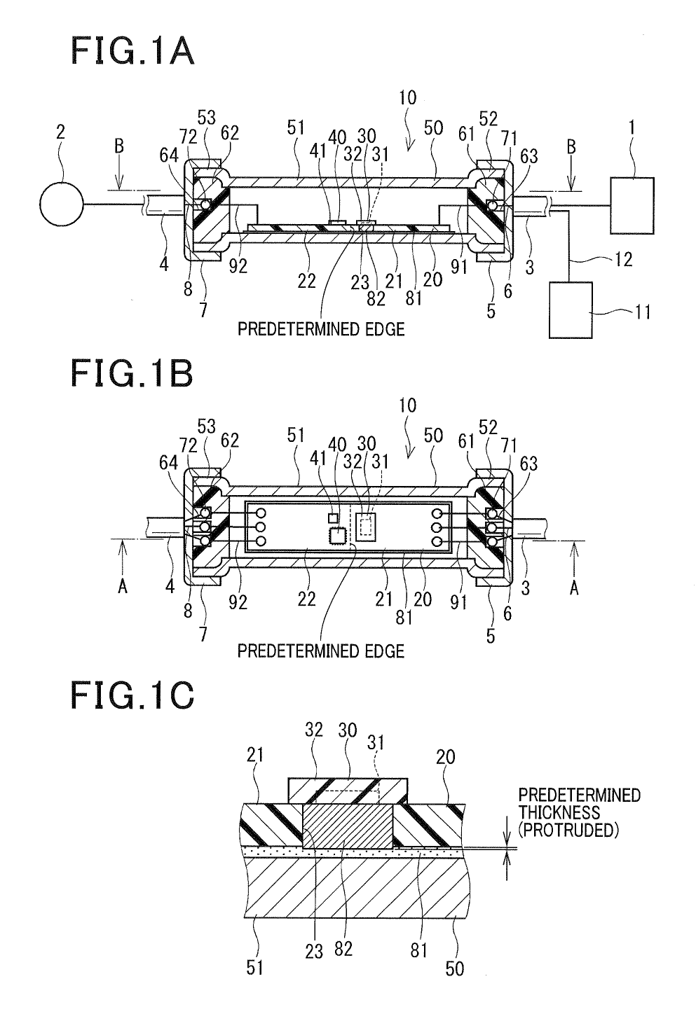

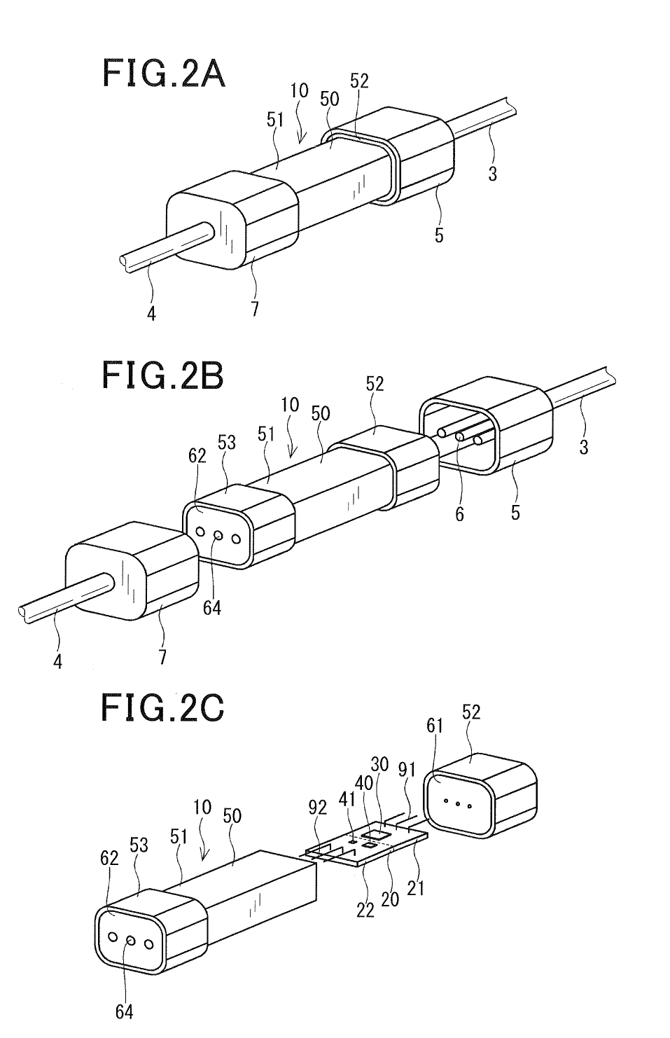

The power conversion apparatus according to the first embodiment is illustrated in the FIGS. 1A, 1B, 2A, 2B and 2C.

The power conversion apparatus 10 according to the first embodiment is used to convert electric power from the power source and supplies the converted power to the electrical load. For example, as shown in FIG. 1A, the power conversion apparatus 10 converts the power from the battery 1 as a power source and supplies the converted power to the motor 2. The battery 1 and the motor 2 are mounted on a vehicle.

The battery 1 serves as a high voltage power source such as secondary batteries including lithium-ion batteries or nickel-metal hydride batteries of which terminal voltage exceeds 100 volts. The battery 1 is used for a power source of a motor generator (not shown) serving as a traction motor mounted on the vehicle. The rotary shaft of the motor generator is mechanically connected to the driving wheel of the vehicle. The motor 2 is a motor of a blower fan used for on-vehicle air-conditioner as an auxiliary unit in the vehicle. The motor 2 is configured, for example, as a three-phase brushless motor.

The power conversion apparatus 10 includes a substrate 20, a power conversion circuit 30, a control circuit 40, a casing 50, an input portion 71 and an output portion 72. The power conversion apparatus 10 is mounted on the vehicle together with the battery 1 and the motor 2. The substrate 20 includes a first substrate 21 and a second substrate 22. The first substrate 21 and the second substrate 22 are printed circuit boards made of resin to form a rectangular shape. According to the first embodiment, the first substrate 21 and the second substrate 22 constitute a substrate 20 having a rectangular shape such that one surfaces of the first and second substrates 21, 22 are located on an identical one plane and the other surfaces of the first and second substrates 21, 22 are located on an identical other plane, that is, the first substrate 21 and the second substrate 22 are joined at a predetermined edge (dashed line as shown in FIG. 1A and 1B) of the first and second substrates 21 and 22.

The power conversion circuit 30 includes a switching element 31 and a sealed package 32. According to the first embodiment, the switching element 31 is a semiconductor device capable of switching, such as IGBT (insulated gate bipolar transistor). The switching element 31 is controlled to be ON and OFF by the control circuit 40 (described later) so as to convert the electric power from the battery 1 to the three-phase AC (alternating current) voltage. The sealed package 32 is made of resin and disposed to cover a part of the switching element 31. The sealed package 32 protects the switching element 31 from suffering from external shock and moisture. The power conversion circuit 30 is also called as a power semiconductor module.

The power conversion circuit 30 is mounted on the first substrate 21 such that the switching element 31 exposed from the sealed package 32 is facing the other surface of the first substrate 21. The control circuit 40 is a microprocessor including a CPU as a calculation means, and ROM and RAM as a memory means. The control circuit 40 executes various processing by the calculation based on the program stored in the ROM. The control circuit 40 is mounted on the other surface of the second substrate 22 that is the same surface on which the power conversion circuit 30 is mounted.

The control circuit 40 and the switching element 31 are electrically connected with a printed wiring on the substrate 20. The control circuit 40 is adapted to transmit an operation signal to the switching element 31 so as to control the switching element 31 to be ON and OFF. The control circuit 40 controls the switching element 31 to be ON and OFF thereby converting the power supplied by the battery 1 to the three-phase AC voltage and supplies the AC voltage to the motor 2.

The control circuit 40 performs triangle-wave PWM (pulse width modulation) processing in response to a command value transmitted by an electronic control unit (ECU) 11 in order to control a command voltage applied to the motor 2. Specifically, a three-phase command voltage is normalized with an input voltage of the switching element to generate a duty signal, and the control circuit 40 compares an amount of the duty signal and a carrier signal (triangle wave shape) so as to generate a PWM signal. Then, the control circuit 40 executes a dead time processing based on the PWM signal and its inverted signal so as to generate the operation signal. It is noted that the control circuit itself operates with a power supplied by a DC-DC converter (not shown) that generates a step-down voltage from the voltage of the battery 1. Meanwhile, the ECU 11 operates with a power supplied by a low voltage power source which is separated from the battery 1. According to the first embodiment, an external drive circuit 41 is mounted on the one surface of the second substrate 22 (i.e., surface on which the control circuit 40 is mounted). The external drive circuit 41 includes an operational amplifier and executes a process for a sensor-less drive of the motor 2.

The casing 50 is made of metal such as aluminum to form a cylindrical shape and constitutes a contour of the power conversion apparatus 10. As shown in FIGS. 1A and 1B, the casing 50 includes a casing body, an input connector 52 and an output connector 53. As shown in FIG. 2A, the casing body 51 is formed to have a rectangular tube shape. The input connector 52 and the output connector 53 are formed to have a rectangular tube shape and integrated to the end portions of the casing body 51 to be disposed on the longitudinal direction of the casing body 51. According to the first embodiment, as shown in FIG. 2B, the outer periphery and the inner periphery of the input connector 52 and the output connector 53 are formed to have larger diameter of the outer periphery and the inner periphery of the casing body 51. A resin 61 is filled inside the input connector 52 and a resin 62 is filled inside the output connector 52, whereby both end portions of the casing body 51 are sealed by the resin 61 and the resin 62. In FIG. 2C, it is illustrated that the input connector 52 and the casing body 51 is cut to separate from each other.

The casing 51 accommodates the substrate 20 including the first substrate 21 and the second substrate 22, the power conversion circuit 30 mounted on the first substrate 21 and the control circuit 40 mounted on the second substrate 22. According to the first embodiment, as shown in FIGS. 1A, 1B and 1C, a sheet 81 is disposed such that the sheet 81 contacts with one of four inner walls of the casing body 51 each having planar shape. The sheet 81 is made of insulated material having a small thermal resistance, containing, for example, silicon. The substrate 20 is accommodated in the casing body 51 such that the substrate 20 contacts with the sheet 81 at a surface of the substrate 20 being opposite to a surface on which the power conversion circuit 30 and the control circuit 40 are mounted. The sheet 81 electrically insulates the substrate 20 and the casing body 51.

As shown in FIG. 1C, according to the first embodiment, the first substrate 21 includes a hole portion 23 that connects the one surface and the other surface at a position corresponding to the power conversion circuit 30. The hole portion 23 is provided with a thermal conduction member 82. The thermal conduction member 82 is made of metal such as copper having thermal conductivity higher than the first substrate which is made of resin. The thermal conduction member 82 contacts with the switching element 31 at the one surface of the thermal conduction member 82. The other surface of the thermal conduction member 82 faces a surface of the sheet 81 of the first substrate and is protruded from the surface of the sheet 81 with a predetermined thickness, thereby contacting closely with the sheet 81.

As shown in FIGS. 1A and 1B, the substrate 20 includes a plurality of input leads 91 and output leads 92 such that one end of both the input leads and output leads are electrically connected to the printed wiring that electrically connects the power conversion circuit 30 and the control circuit 40. An input portion 71 is formed at the other end of the input lead 91. Similarly, an output portion 72 is formed at the other end of the output lead 92. The input portion 71 is disposed inside the input connector 52 to be embedded to the resin 61. The output portion 72 is disposed inside the output connector 52 to be embedded to the resin 62.

In the battery 1, an input harness 3 is connected. The input harness 3 includes a harness connector 5 having a bottomed cylindrical shape, at an end portion being opposite to the battery 1 of the input harness 3. The harness connector 5 is made of meal such as aluminum. The battery 1 and the power conversion apparatus 10 can be mechanically connected such that the inner wall of the harness connector 5 is engaged with the outer wall of the input connector 52 to connect the harness connector 5 with the input connector 52. Meanwhile, the battery 1 and the power conversion apparatus 10 can be mechanically disconnected such that the harness connector 5 and the input connector 52 are separated so as to pull the input connector 52 out from the harness connector 5. Thus, the input connector 52 connects the harness connector 5 which is an end portion of the input harness 3 connected to the batter 1, to be mountable and demountable from/to the input connector 52.

As shown in FIG. 1A and FIG. 1B, when the harness connector 5 is being connected to the input connector 52, the lead 6 of the input harness 3 reaches the input portion 71 via the hole portion 63 of the resin 61 whereby the lead 6 is electrically connected to the input portion 71. According to the first embodiment, the input harness 3 includes a signal line 12 for transmitting the command value transmitted by the ECU 11 to the control circuit 40, and a lead wire (not shown) through which the power used for the control circuit is transmitted. As similar to the lead 6, the signal line 12 and the lead wire are electrically connected to the input portion 71 when the harness connector 5 is connected to the input connector 52.

In the motor 2, an output harness 4 is connected. The output harness 4 includes a harness connector 7 having a bottomed cylindrical shape at the end portion being opposite to the motor 2. The harness connector 7 is made of metal, e.g. aluminum. The motor 2 and the power conversion apparatus 10 can be mechanically connected such that the inner wall of the harness connector 7 is engaged with the outer wall of the output connector 53 to connect the harness connector 7 with the input connector 53. Meanwhile, the motor 2 and the power conversion apparatus 10 can be mechanically disconnected such that the harness connector 7 and the output connector 53 are separated so as to pull the output connector 53 out from the harness connector 7. Thus, the output connector 53 connects the harness connector 7 which is an end portion of the output harness 4 connected to the motor 2, to be mountable and demountable from/to the output connector 53.

As shown in FIGS. 1A and 1B, when the harness connector 7 is being connected to the output connector 53, the lead 8 of the output harness 4 reaches the output portion 72 via the hole portion 64 of the resin 62 whereby the lead 8 is electrically connected to the output portion 72. Thus, the power conversion apparatus 10 according to the first embodiment is configured to integrate the input connector 52 and the output connector 53 together with the casing body 51, wherein the input connector 52 connects the input harness 3 to be mountable and demountable and the output connector 53 connects the output harness 4 to be mountable/demountable. It is noted that the input harness 3 is connected to the battery 1 and the output harness 4 is connected to the motor 2.

Next, the operation of the power conversion apparatus 10 according to the first embodiment is described as follows. The control circuit 40 generates the operation signal in response to the command value transmitted from the ECU 11 and transmits the operation signal to the switching element 31. The switching element 31 operates to be ON and OFF in response to the operation signal. Hence, the power of the battery 1 received by the power conversion apparatus 10 via the input harness 3 is converted to three-phase AC voltage and the converted three-phase AC voltage is supplied to the motor 2 via the output harness 4, whereby the motor 2 is driven to rotate.

The switching element 31 produces heat when operating to be ON and OFF. According to the first embodiment, the thermal conduction member 82 is disposed between the switching element 32 and the sheet 81. Hence, the heat produced by the switching element 31 can be promptly radiated via the thermal conduction member 82, the sheet 81 and the casing body 51. As a result, a loss of the power conversion circuit 30 due to the heat can be suppressed and the heat produced by the switching element 31 conducting to the control circuit 40 and the external drive circuit 41 can be suppressed.

According to the first embodiment as described above, following advantages can be obtained.

(1) Since the power conversion circuit 30 and the control circuit 40 are accommodated in the casing body 51, even when the power conversion apparatus 10 is mounted at a portion in a vehicle where a vibration is likely to occur, vibration stress propagating separately to the power conversion circuit and the control circuit can be prevented. Therefore, the stress concentrating to an electrical conduction path between the power conversion circuit 30 and the control circuit 40 can be avoided. As a result, comparing a power conversion apparatus wherein the power conversion circuit is accommodated in the casing body 51 and the control circuit is disposed outside the casing body, and the power conversion apparatus 10 according to the first embodiment, the power conversion apparatus 10 according to the first embodiment can maintain favorable electrical conductance between the power conversion circuit 30 and the control circuit 40 which constitute the power conversion apparatus 10.

According to the first embodiment, the casing 50 covers the power conversion circuit 30, the control circuit 40, the input portion 71 and the output portion 72. Hence, by using the casing 50, the power conversion circuit 30, the control circuit 40, the input portion 71, the output portion 72 and connecting portions among these components suffering from external disturbance such as mechanical shock, heat, liquid material such as water and foreign materials having conductivity can be avoided. Moreover, the casing 50 is made of metal such as aluminum capable of shielding electromagnetic waves. Therefore, electromagnetic noise entering to the power conversion circuit 30, the control circuit 40, the input portion 71, the output portion 72 can be suppressed. Also, electromagnetic noise produced by the above-described components radiating outside the casing 50 can be suppressed. Furthermore, according to the first embodiment, the casing 50 is made of metal such as aluminum having relatively high thermal conductivity, whereby the heat produced inside the casing 50 can be promptly radiated outside the casing 50.

(2) According to the first embodiment, the casing body 51 is formed to have cylindrical shape. The input connector 52 and the output connector 53 are formed at the end portions of the casing body 51. That is, the power conversion apparatus 10 according to the first embodiment can be called a stick-shaped and small-sized power conversion apparatus with integrated connectors.

(3) Further, according to the first embodiment, the power conversion apparatus 10 includes the insulated sheet 81 such that one surface of the sheet 81 contacts with an inner wall of the casing body 51. The casing body 51 is made of metal. The first substrate 21 is disposed such that a surface of the first substrate being opposite to the surface where the power conversion circuit 30 is disposed, contacts with the other surface of the sheet 81. As a result, the first substrate 21 and the casing body 51 are insulated and heat produced by the power conversion circuit 30 can be radiated outside the power conversion apparatus 10 promptly via the sheet 81 and the casing body 51.

(4) The first substrate 21 includes the hole portion 23 which is formed to have contact between the one surface thereof and the other surface thereof. The first substrate 21 also includes the thermal conduction member 82 having thermal conductance higher than that of the first substrate 21 and being disposed in the hole portion 23 to contact with both the power conversion circuit 30 and the sheet 81. Therefore, heat produced by the power conversion circuit 30 can be promptly radiated outside the power conversion apparatus 10 via the thermal conduction member 82, sheet 81 and the casing body 51. As a result, a loss of the power conversion circuit 30 due to the heat can be suppressed and the heat produced by the power conversion circuit 30 conducting to the control circuit 40 and the external drive circuit 41 can be suppressed.

(5) According to the first embodiment, the thermal conduction member 82 is disposed to be protruded from a surface of the first substrate 21 facing to the sheet 81, with a predetermined thickness, thereby contacting closely with the sheet 81. Thus, the heat produced by the power conversion circuit 30 can be radiated outside the power conversion apparatus 10 promptly via the thermal conduction member 82, the sheet 81 and the casing body 51.

According to the first embodiment, the input connector 52, the output connector 53, the harness connectors 5 and 7 connected to the input connector 52 and the output connector 53 by engaging therewith, are made of metal such as aluminum. Thus, the heat produced by the power conversion circuit 30 can be radiated outside the power conversion apparatus 10 via the input connector 52, the output connector 53, the harness connector 5 and the harness connector 7.

(6) Thus, according to the first embodiment, various measures are applied to radiate the heat produced by the power conversion circuit 30 whereby the first substrate 21 and the second substrate 22 are integrated and the power conversion circuit 30 and the control circuit 40 are disposed on the same substrate 20. Since the first substrate 21 and the second substrate 22 are integrated with each other, the number of components can be reduced.

### Second Embodiment

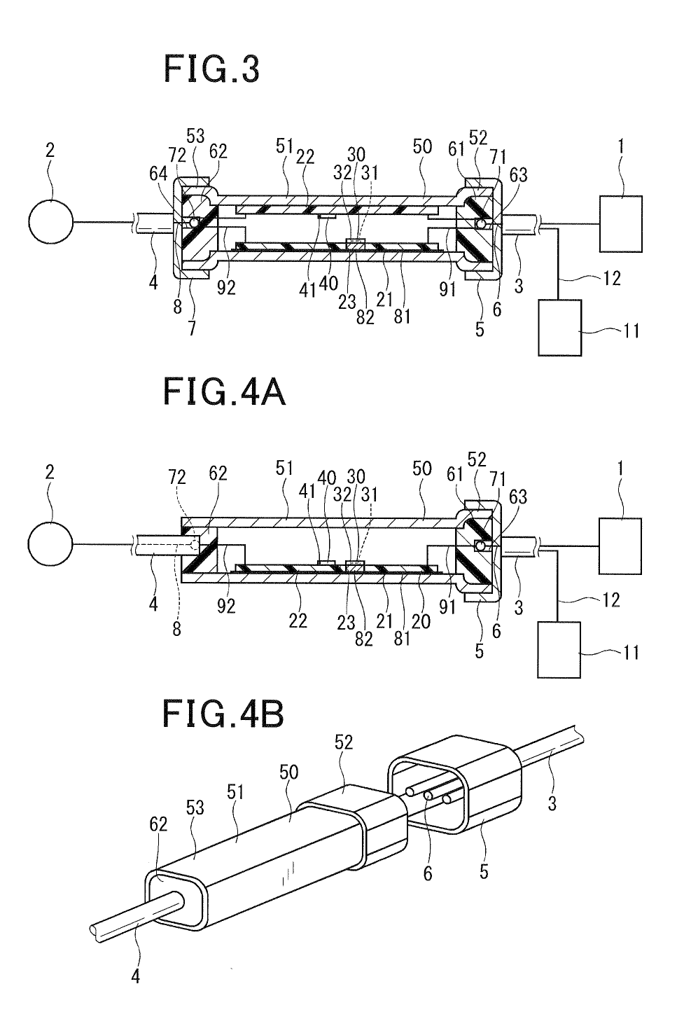

The power conversion apparatus according to the second embodiment of the present disclosure is shown in FIG. 3. In the second embodiment, shapes of the first and second substrates 21 and 22 and the disposition thereof differ from that of the first embodiment.

According to the second embodiment, the first substrate 21 and the second substrate 22 are disposed independently. Similar to the first embodiment, the first substrate 21 is accommodated in the casing body 51 such that a surface of the substrate 21 opposite to the surface on which the power conversion circuit 30 is mounted, is contacted with the sheet 81. Meanwhile, the second substrate 22 is accommodated in the casing body 51 such that a surface of the substrate 22 opposite to the surface on which the control circuit 40 and the external drive circuit 41 are mounted, is contacted with an inner wall opposite to the surface on which the sheet 81 is disposed among the four inner walls each having a planar shape of the casing body 51.

As described above, according to the second embodiment, the first substrate 21 and the second substrate 22 are disposed independently to be apart from each other in the casing body 51.Therefore, heat produced by the power conversion circuit 30 conducting to the control circuit 40 and the external drive circuit 41 can be suppressed.

### Third Embodiment

The power conversion apparatus according to the third embodiment is illustrated in FIG. 4. The third embodiment differs from the first embodiment such that the output connector 53 according to the first embodiment is not included in the configuration of the third embodiment.

In the third embodiment, the casing 50 includes only the input connector 52 and does not include the output connector 53 (FIG. 1A). According to the third embodiment, a resin 62 is filled inside the end portion being opposite to the input connector 52. The output portion 72 is disposed inside the end portion of the casing 51 to be embedded to the resin 62.

The output harness 4 does not include the harness connector 7 (FIG. 1A). The end portion of the harness 4 in the opposite side of the motor 2 is embedded to the resin 62, that is, the end portion is not mountable/demountable. The lead 8 of the output harness 4 is connected to the output portion 72.

As described above, according to the third embodiment, the casing 50 does not includes the output connector 53. Accordingly, the size of the power conversion apparatus can be shrunk. Also, according to the third embodiment, the harness connector 7 is not necessary for the output harness 4. Hence, the number of components can be reduced and the area around the power conversion apparatus necessary for connecting the power conversion apparatus and the output harness can be reduced as well. Further, since the output harness 4 and the power conversion apparatus are integrated, the power conversion apparatus can be handled easily.

### Fourth Embodiment

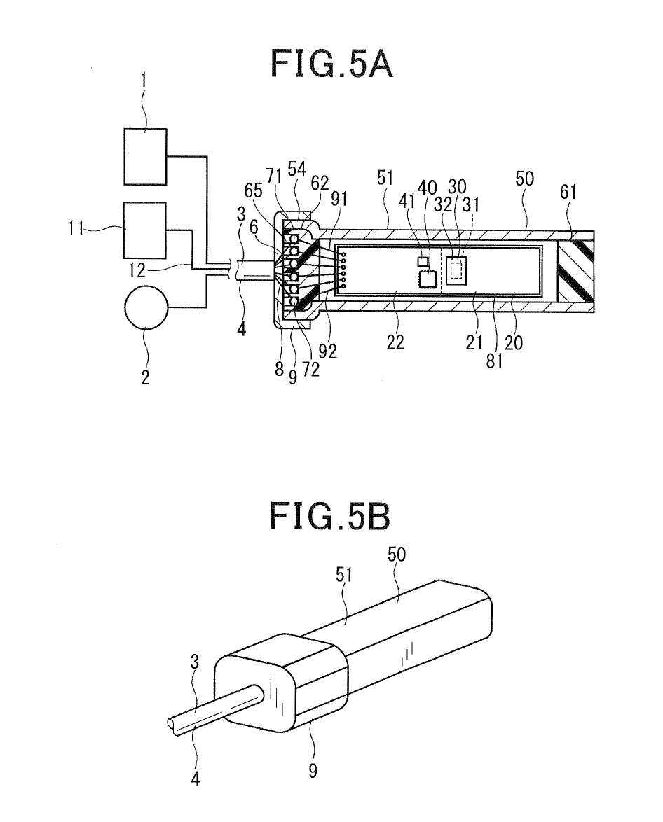

The power conversion apparatus according to the fourth embodiment is shown in FIGS. 5A and 5B. The configuration of the fourth embodiment differs from that of the first embodiment in its disposition of the input connector and the output connector in the casing body.

According to the fourth embodiment, the casing 50 includes an input-output connector 54. The input-output connector 54 is formed to have a rectangular tube shape and integrated to one end portion of the casing body 51 to be disposed on the longitudinal direction of the casing body 51. The inner periphery and the outer periphery of the input-output connector 54 are formed to be larger than that of the inner periphery and the outer periphery of the casing body 51. The resin 62 is filled inside the input-output connector 54. Also, the resin 61 is filled inside the other end portion in the opposite side of the input-output connector 54 of the casing 51. Accordingly, both ends of the casing body 51 are sealed by the resin 61 and the resin 62. According to the fourth embodiment, the input portion 71 and the output portion 72 are located at inside area of the input-output connector 54 to be embedded to the resin 62.

According to the fourth embodiment, the end portion of the input harness 3 which is on the opposite side of the battery 1 and the end portion of the output harness 4 which is opposite side of the motor 2 are integrated to the harness connector 9 having a bottomed cylindrical shape. The harness connector 9 is disposed at the end portion of the output harness 4 which is on the opposite side of the motor 2. The harness connector 9 is made of metal, e.g. aluminum. The harness connector 9 is connected to the input-output connector 54 such that the inner wall of the harness connector 9 is engaged with the outer wall of the input-output connector 54, whereby the battery 1 and the motor 2, and the power conversion apparatus can be mechanically connected from each other. Meanwhile, the battery 1 and the motor 2, and the power conversion apparatus 10 can be mechanically disconnected such that the harness connector 9 and the input-output connector 54 are separated so as to pull the input-output connector 54 out from the harness connector 9. Thus, the input-output connector 54 connects the harness connector 9 that includes the end portion of the input harness 3 connected to the batter 1 and the end portion of the output harness 4 connected to the motor 2, to be mountable/demountable from the input-output connector 54. The input-output connector 54 corresponds to the input connector and the output connector.

As shown in FIG. 5A, when the harness connector 9 is being connected to the input-output connector 54, the lead 6 of the input harness 3 reaches the input portion 71 via a hole portion 65 of the resin 62 and is electrically connected to the input portion 71. The input harness 3 includes a signal line 12 that transmits the command value transmitted from the ECU 11 to the control circuit 40, a lead wire that transmits power used for operating the control circuit 40 (not shown). The signal line 12 and the lead wire are electrically connected to the input portion 71 as similar to the lead 6, when the harness connector 9 is connected to the input-output connector 54. As shown in FIG. 5A, when the harness connector 9 is being connected to the input-output connector 54, the lead 8 of the output harness 4 reaches the output portion 72 via the hole portion 65 of the resin 62 and is electrically connected to the output portion 72.

As described above, according to the fourth embodiment, the input connector and the output connector are integrated to be disposed at one end portion of the casing body 51 so that the size of the power conversion apparatus can be shrunk as similar to the third embodiment. Moreover, the power conversion apparatus can be connected to the input harness 3 and the output harness 4 at only the one end side (input-output connector 54 side) of the casing body 51.

### Other Embodiments

According to the first embodiment, a casing is exemplified such that the input connector and the output connector are disposed at respective ends of the casing body. In the third embodiment, the casing is exemplified such that the input connector is disposed at only one end portion of the casing body. In this embodiment, the casing may have the output connector at one end portion or the other end portion of the casing body.

According to the above-described embodiments, the casing body is formed to have a rectangular tube shape. However, in the other embodiments of the present disclosure, the casing body may have various shapes such as a cylindrical shape, an elliptic cylindrical shape, a triangle tube shape and other polygonal tube shapes. Similarly, the input connector and the output connector can be formed to have various shapes.

According to the above-described embodiments, the input connector and the output connector are formed to be male type connectors and connected to the harness connectors having female type shape. However, according to the other embodiments of the present disclosure, the input and output connectors may be formed to be female type connectors and can be connected to harness connectors having male type shape.

According to the second embodiment, the first substrate is disposed on one inner wall among the four inner walls of the casing body having rectangular tube shape, and the second substrate is disposed at an inner wall being opposite to the one inner wall on which the first substrate is disposed. In the other embodiments, the second substrate can be disposed at an inner wall adjacent to an inner wall on which the first substrate is disposed.

According to the other embodiments of the present disclosure, the first substrate may employ a configuration in which no hole portions is disposed in the first substrate and no thermal conduction member is disposed. Moreover, no sheet may be disposed between the first substrate and the inner wall of the casing body, and the casing may not be limited to metal, however, resin material can be used for the casing.

According to the other embodiments, a sealed package is not necessarily used for the switching element. In other word, the power conversion apparatus may not include the sealed package. Further, the switching element is not limited to the IGBT, however, FET (field effect transistor), e.g. MOSFET (metal-oxide-semiconductor FET), JFET (junction FET) and MESFET (metal-semiconductor FET), GTO (gate turn-off thyristor), power transistors, and other semiconductor devices capable of switching between ON and OFF can be used.

The power conversion apparatus according to the present disclosure is not limited to a blower fan used for an auxiliary unit mounted on the vehicle, however, the power conversion apparatus according to the present disclosure can be adapted to various equipments capable of operating with a power supplied by the power conversion apparatus, such as a motor used for a water pump that circulates cooling water of the internal combustion engine mounted on the vehicle, a heater of an on-vehicle air-conditioner, a rotary electric machine, an electrical load, a power supply unit, a control apparatus, and measurement equipment. Thus, the present disclosure is not limited to the embodiment described above but may be modified in variable manners within a scope not departing from the spirit of the present disclosure.

What is claimed is:

1. A power conversion apparatus that converts power from a power source to supply an electrical load with a converted power comprising:
a first substrate;
a second substrate;
a power conversion circuit mounted on the first substrate, converting the power from the power source to generate the converted power;
a control circuit mounted on the second substrate, controlling an operation of the power conversion circuit thereby supplying the electrical load with the converted power;
a casing including a casing body that accommodates the first substrate, the second substrate, the power conversion circuit and the control circuit;
an input portion that electrically connects a lead of an input harness connected to the power source; and
an output portion that electrically connects a lead of an output harness connected to the electrical load, wherein
the casing includes an input connector integrated with the casing body to cover the input portion and an output connector integrated with the casing body to cover the output portion, the input connector connects an end portion of the input harness to be mountable and demountable from and to the input connector, the output connector connects an end portion of the output harness to be mountable and demountable from and to the output connector.

2. The power conversion apparatus according to claim 1, wherein the casing body is formed to have cylindrical shape, the input connector or the output connector are formed at an end portion of the casing body.

3. The power conversion apparatus according to claim 1, wherein the first substrate and the second substrate are formed to be integrated with each other.

4. The power conversion apparatus according to claim 2, wherein the first substrate and the second substrate are formed to be integrated with each other.

5. The power conversion apparatus according to claim 1, wherein the power conversion apparatus further includes a sheet made of insulated material disposed such that the one surface of the sheet contacts with one of four inner walls of the casing body each having planar shape, the casing body is made of metal, and the first substrate is disposed such that the first substrate contacts with the other surface of the sheet at a surface of the first substrate being opposite to a surface on which the power conversion circuit is mounted.

6. The power conversion apparatus according to claim 2, wherein the power conversion apparatus further includes a sheet made of insulated material disposed such that the one surface of the sheet contacts with one of four inner walls of the casing body each having planar shape, the casing body is made of metal, and the first substrate is disposed such that the first substrate contacts with the other surface of the sheet at a surface of the first substrate being opposite to a surface on which the power conversion circuit is mounted.

7. The power conversion apparatus according to claim 3, wherein the power conversion apparatus further includes a sheet made of insulated material disposed such that the one surface of the sheet contacts with one of four inner walls of the casing body each having planar shape, the casing body is made of metal, and the first substrate is disposed such that the first substrate contacts with the other surface of the sheet at a surface of the first substrate being opposite to a surface on which the power conversion circuit is mounted.

8. The power conversion apparatus according to claim 5, wherein the first substrate includes a hole portion that connects one surface and the other surface of the first substrate, and a thermal conduction member disposed at the hole portion so as to contact with the power conversion circuit and the sheet.

9. The power conversion apparatus according to claim 8, wherein the thermal conduction member is disposed to be protruded from a surface of the first substrate facing to the sheet, with a predetermined thickness.
